(19) United States
(12) Patent Application Publication
(10) Pub. No.: US 2005/0136162 A1
(43) Pub. Date: Jun. 23, 2005

(54) Process for the fractionation of oilseed press cakes and meals

(76) Inventors: Sten Uyo Kvist, Ooaura (SE); Tommie Ingvar Carlsson, Lereercet (SE); John Mark Lawther, Roskilde (DK); Fernando Basile DeCastro, Sao Paulo (BR)

Correspondence Address: Gauthier & Connors LLP, Suite 3300, 225 Franklin Street, Boston, MA, 02110, US

(21) Appl. No.: 10/815,045

(22) Filed: Mar. 30, 2004

Related U.S. Application Data
(63) Continuation of application No. PCT/SE02/01816, filed on Oct. 4, 2002.

(30) Foreign Application Priority Data
Oct. 4, 2002 (WO) PCT/SE02/01816
Oct. 4, 2001 (SE) 0103329-9

(51) Int. Cl. A23L 1/00

(52) U.S. Cl. 426/455; 426/629; 426/52

(57) ABSTRACT

A process for the fractionation of oilseed cakes and meals (e.g. rapeseed cake, soybean meal, and cottonseed cake) is disclosed. This invention describes a fractionation process, in which the said cake or meal is subjected to enzymatic treatment with polysaccharidases with intermittent wet milling, followed by heat treatment to facilitate separation of insoluble from soluble phase by centrifugal forces. Sequential centrifugation and ultrafiltration steps are carried out in order to yield a fibre-rich fraction, at least three protein-rich fractions, in the case of oilseed cakes at leas one emulsified oil fraction, a sugar-rich fraction, and a phytate-rich fraction. This invention also describes the use of the above-mentioned fractions in food, feed, nutraceutical and pharmaceutical applications.

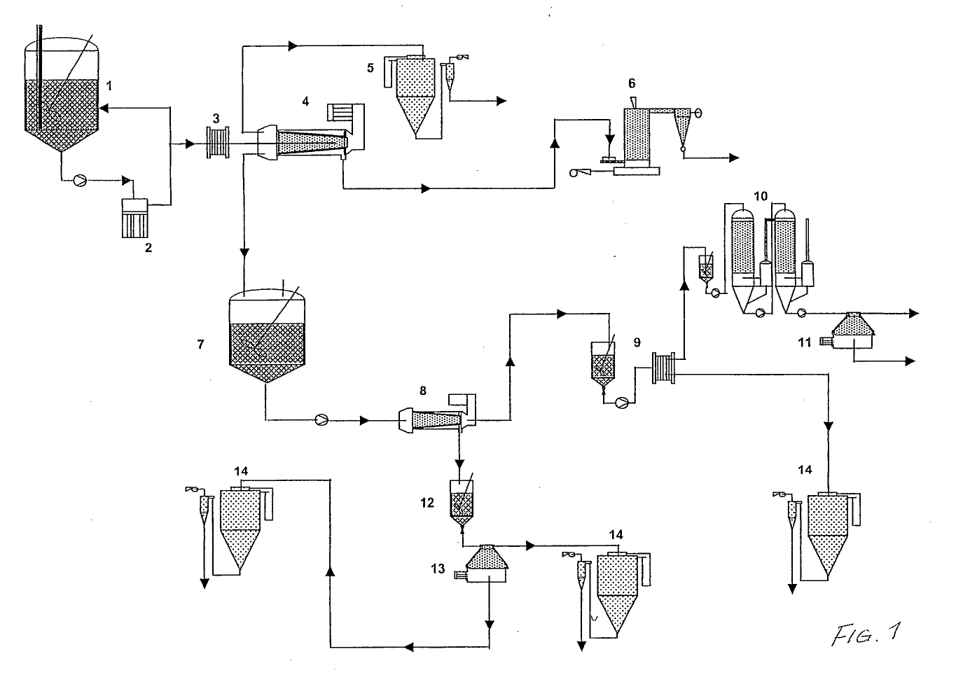

### TECHNICAL FIELD

The present invention relates to a process for the fractionation of oilseed press cakes and meals, and fractions thereby recovered including their end-uses.

### INTRODUCTION

The primary aim of industrial processing of oilseeds has been to maximise oil extraction. This has been achieved by using solvent extraction processes or combination of mechanical (expeller pressing) and solvent extraction. The resulting products from such extraction processes, i.e. oil and meal, have been widely used in both food and feed applications.

Even though there is no absolute agreement in the terminology used to define oilseed residues, the term oilseed meal will be used hereinafter to define the protein-fibre rich oilseed residue produced from either 1) a solvent extraction or 2) an expeller pressing and solvent extraction technology, whilst oilseed cake will be used hereinafter to define the fibre-protein-oil rich residue produced from the expeller pressing technology only.

In addition to oil and emulsifiers, oilseeds are a very interesting source of proteins, fibres and other biologically active components. In recent years, there has been a growing interest in the production and utilisation of such components. Existing commercial processes utilised for extracting such components are primarily chemical processes and targeted at oilseed meals rather than press cakes.

Large quantities of chemical-free press cakes are available in the market, which could be further processed without chemicals and yield interesting products from the technical and marketing point of view. Currently, all such press cakes are being marketed as low value commodities. Additionally, significant ton amounts of press cakes, which are currently being extracted with solvents in a second extraction step, could become available for fractionation.

This invention relates to a process for a chemical-free fractionation of oilseed meals and press cakes into at least three protein-rich fractions, at least one fibre fraction, a sugar syrup fraction, and a phytate fraction, and optionally an emulsified oil fraction.

The invention is based upon the treatment of oilseed press cakes or meals whereby the use of specific carbohydrate-degrading enzymes of the type xylanase, hemicellulase such as pentosanase, arabinase, pectinase and beta glucanase, is combined with wet milling under appropriate conditions of temperature, i.e. from 20 to 90° C., more preferably from 30 to 50° C., and pH from 4 to 6.5. The resulting hydrolysate is heated at 50 to 95° C. and the above-listed fractions are separated using centrifugal separation and size-exclusion methods at such an elevated temperature. An optional fast heat treatment in a heat exchanger, specifically designed to inactivate exogenous enzymes, can be carried out either immediately after the enzymatic hydrolysis or prior to the drying of each fraction.

### PRIOR ART

Various technologies based on use of chemicals (alkali and salts) have been developed for extracting and recovering various components, in particular proteins, from oilseeds and their respective meals and cakes.

Technologies based upon the solubilisation of proteins at alkali pH followed by separation of the insoluble fraction and ultimately adjusting the pH of the protein-containing solution to their isoelectric point to cause protein precipitation has been widely demonstrated in prior art such as in patents GB 671 935; GB 900 126; EP 0 289 183; EP 0 466 524; EP 0 522 800; CN 1 121 926. Despite the acceptable protein yields obtained in such process the high chemical input, which leads to direct and indirect costs, the presence of chemical contaminants in the end-products and the loss of protein functionality due to its denaturation amongst others could be listed as the most serious handicaps of such an approach. In order to overcome or minimise protein denaturation U.S. Pat. No. 4,188,399 patent discloses a process in which protein is solubilised at milder pH conditions (pH 5.1-5.9), the solids are separated of the liquid fraction, and the pH of the liquid fraction adjusted to match the protein isoelectric point (pH 3-5) for further separation of a functional protein by ultrafiltration.

No reference is made about protein yields, but the mild treatment conditions described in the said patent suggest that low yields are obtained.

U.S. Pat. No. 1,041,717 discloses a method to solubilise and isolate vegetable proteins by using a combination of hydrogen peroxide (alkaline treatment) and enzymatic hydrolysis with proteases. The reported low protein extraction rates (<50%) and excessive use of hydrogen peroxide (up to 13.6%) have serious impact on the economy of the proposed technology.

An alternative concept to alkali solubilisation of protein followed by precipitation at the isoelectric point is that of salting out proteins. U.S. Pat. Nos. 4,208,323 and 5,877,086 describe protein extraction procedures using food grade sodium chloride at specified pH and ionic strength. The above-mentioned technologies are successful in producing highly functional and non-denatured protein isolates from oil seed meals. This is, however, counterbalanced by the low protein yields and large quantities of water and salt utilised in the process.

Although most development on protein extraction of vegetable protein sources has been focused on chemical-based technologies, as described in the above-mentioned examples, other non-chemical processes have also been developed.

GB patent 598,641 informs on a process to extract proteins from leguminous protein materials previously treated with proteases. Partly hydrolysed proteins and their hydrolysis products (peptides and aminoacids) are recovered in a solution, which is further concentrated by evaporation or drying. The inventors make no reference to the use of cell wall degrading enzymes and other key inventive steps of the present invention.

A further invention on the use of enzymes to help extracting proteins from defatted solvent extracted, non-wet milled, oil seed meals is disclosed by DE 19907723 patent. The inventor refers to a method, which uses carbohydrate-degrading enzymes, prior to separation of the protein at the isoelectric point. The invention is focused exclusively on the recovery of a protein fraction (protein concentrate), which is precipitated at the isoelectric point, and a fibrous by-product. The remaining protein mass, which does not precipitate at the condition specified in the patent, remains in a sugar solution derived from the fibre hydrolysis and is regarded to be a low value by-product and as such used for animal feeding. The inventor has failed to realise that these are valuable proteins and should be recovered by other means. A further problem is that anti-nutritive factors, in particular phytates, present in the raw material will be concentrated in the by-product fraction. This will eventually lead to problems when considering animal feeding applications. No inventive steps on removal of such anti-nutritive factor have been suggested. Furthermore, the invention completely disregards the use or processing of fat-rich oilseed residues such as press cakes, and as such no proposals for fat separation have been disclosed.

A novel and alternative technology to the press expeller or solvent extraction process was developed initially for the extraction of oil from rapeseed using enzymes and wet separation (Olsen, 1987, Olsen & Christensen, 1987). The process is based on the early inactivation of the rapeseed enzymes by heat treatment. The seeds are then hydrolysed with polysaccharidases of the type pentosanase, hemicellulase, cellulase and pectinase, to disrupt the fibrous mass, thereby facilitating the subsequent removal of oil by centrifugation. In addition to oil, the process also yields protein meal, fibre (hull) and sugars as side streams, which contain various amounts of oil as a contaminant. The lower relative yield of oil compared to conventional extraction processes (10-20% less), the low protein meal yield (<15%), and the low market price obtained from the suggested end-uses for the protein meal, hull and sugar fractions have been important obstacles for the implementation of this technology as an alternative to conventional oil extraction process. In order to reach a more attractive economy, better fractionation and more end-products with different functionalities and higher market value are needed. Additionally, removal and recovery of anti-nutritive factors such as phytate from the sugar fraction is crucial both to increase the market value of such a fraction (better nutritive value), and to yield another high value fraction (as phytate) in the process.

The inactivation or separation of anti-nutritive factors such as phytates, which can be present in considerable amounts in plant materials, is disclosed in U.S. Pat. No. 3,736,147. The invention refers to an ultrafiltration procedure to remove phytate at various pH ranges. It is suggested the use of divalent cations, phytase enzymes or strong chelating agents at the following pH ranges, respectively, 2-4.5, 4.5-7 or 7-11.

It is apparent that none of the abovementioned disclosures have arrived at a chemical-free fractionation process based upon the use of polysaccharidases and designed to meet the requirements of oilseed meal and cake processing, which focus on the high recovery (up to 60%) of more than one protein fraction with different functionalities, whilst producing a fibre-rich fraction, optionally an emulsified oil fraction, sugar fraction containing significantly lower levels of phytate, and a phytate fraction.

The main objectives of this invention were to:
1. Develop a cost effective and efficient wet fractionation process to yield high value protein, fat, sugar, fibre and phytate fractions of distinct properties.
2. Combine the use of enzymatic treatment with polysaccharidase with wet milling, followed by heat treatment to facilitate the removal of solubles by centrifugal separation from the hydrolysate.
3. Maximise the recovery, after polysaccharidase treatment, of non-cell wall bound proteins into various protein-rich fraction by means of centrifugation and ultrafiltration, which exhibit rather distinct functionality and chemical composition, and therefore are suitable to different food and feed markets.
4. To maximise the extraction of a fat fraction from oilseed cakes, which consists primarily of an oil emulsion to be utilised as a high value feed additive.
5. To avoiding enzyme inactivation as a possibility so as to retrieve the enzyme cost by producing feed-grade fractions containing high polysaccharidase activity.
6. To maximise the removal of phytate originally present in the sugar fraction, without using exogenous divalent cations, phytases or chelating agents, as a means to both increase the feed value of the sugar fraction and produce another high value fraction rich in phytates.

### DESCRIPTION OF THE PREFERRED EMBODIMENTS

The inventors have developed an industrial wet fractionation process to produce, without the use of chemicals, various protein fractions, fibre, sugars with low phytate content, optionally an oil emulsion and a phytate fraction, from oilseed meals to be utilised in various market applications.

### EXAMPLE 1

Rapeseed cake obtained from press expeller process and containing 31% protein and 23.5% oil was subjected to an enzymatic hydrolysis with a multi enzyme complex containing beta glucanase, pentosanase, hemicellulase and pectinase activities in an amount of 1000 IU/g of substrate. The reaction mixture containing approximately 19% dry matter was continuously stirred and intermittently milled, at 1 hr intervals, through a wet mill to facilitate access of the enzymes into the substrate matrix and the dispersion of hydrolysis end-products. After 3 hrs of hydrolysis, the reaction mixtures was then heated up to 95° C. and centrifuged whilst hot in order to separate the solubles from the precipitate fraction, which consisted primarily of hulls. The solubles were re-suspended in water and centrifuged and five layers were identified and separated, i.e. two top layers of emulsified oil, one middle layer of solubles and two bottom layers of protein fibre-rich precipitates. The soluble middle layer was then filtered through an ultrafilter fitted with 10 kDa membrane from which a retentate (protein) and a permeate (sugars) were collected. After centrifugation of the retentate a protein-rich precipitate and a supernatant were obtained. The permeate phase was centrifuged to obtain a first precipitate (phytate-rich fraction). The permeate soluble phase was then evaporated to 40° Brix and centrifuged to separate a second phyate-rich precipitate and a sugar-rich supernatant. Except the sugar supernatants, all other fractions were freeze-dried prior to analysis.

The yields of fibre, emulsified oil and sugar-rich fractions were 37.6, 16.1 and 12.8%, respectively. The protein content of the 4 protein fractions ranged from 32.6 to 92% and an overall protein extraction of 71.3% was achieved. The light phase emulsified oil was the predominant phase representing 85% of the oil phase, and consisted of 73% oil and 20% protein amongst others. The phytate content in the two phytate-rich fractions varied from 30.1 to 73%.

### EXAMPLE 2

Rapeseed cake was subjected to similar treatment conditions as described in Example 1, except that a multi enzyme complex containing twice higher hemicellulase activity was used. The extent of fibre hydrolysis was significantly higher (29%) than in Example 1. Equally, a higher protein extraction rate was achieved. The yields of fibre, emulsified oil and sugar-rich fractions were 29.5, 17.3 and 19.7%, respectively.

The results indicated that boosting fibre hydrolysis by altering specific enzyme activities improves the extraction rates of soluble components, i.e. proteins and oils.

### EXAMPLE 3

A similar trial with rapeseed cake was carried out this time with enhanced enzymatic activity against hemicelluloses and highly branched pectins. A further improvement in the fibre hydrolysis with a yield of 23% was achieved. Protein and oil overall extraction rates of 83% and 86% were achieved, and considered to be significantly superior to those described by prior art on non-chemical fractionation processes.

### EXAMPLE 4

A fractionation trial with defatted rapeseed meal (39.3% protein and 2.3% fat), which had been previously extracted by press expeller and hexane, was carried out as described in Example 1. The soluble phase from the first separation was re-suspended and centrifuged. Three layers were identified and separated, i.e. one top layer of solubles and two bottom layers of protein fibre-rich precipitates. The soluble top layer was then filtered through an ultrafilter fitted with 10 KDa membrane from which a retentate (protein) and a permeate (sugars) were collected. After centrifugation of the retentate a protein-rich precipitate with 94.2% protein content and a supernatant were obtained. The permeate phase was evaporated to 40° Brix and centrifuged to separate a phytate-rich precipitate from a sugar-rich supernatant.

The yields of fibre and sugar-rich fractions were 31.3 and 17.3%, respectively. The protein content of the 4 protein fractions ranged from 33.0 to 94.2% and an overall protein extraction of 75.6% was achieved.

The recovery of the present protein fractions can contribute to an increase on the overall protein yield by as much as 100% of the expected yields in the above mentioned DE-A-19 907 723.

End-Uses

Fibre Fraction

Despite of the high extraction rate of both proteins and oil the residual insoluble fraction, hence fibre-rich fraction is still an interesting raw material for animal feeding, particularly ruminants.

Fibre fractions produced from oil seed meals and cakes contained less protein and oil than observed in the original material. The nutritive value of the fibre fraction was estimated, by full proximal analysis and “in vitro” digestibility, to be approximately 70% of raw material.

The high lignin content (15-27%) and the free-flowing nature of fibre fraction also indicate its potential as an energy source for biomass combustion.

Protein Fractions

Protein fractions produced according to this invention have distinct composition, nutritive value and functionality. Two protein fractions extracted at early stages in the process have generally a high fibre content, which may vary from 20 to 55% depending on raw material composition and rate of hydrolysis. The protein content ranges from 30 to 65%. These protein fractions are ideal feed ingredients due to: a) high protein level and quality, b) highly digestible fibre, and c) low phytate level.

These low solubility protein fractions can also be used in food applications particularly as texturizers.

More soluble protein fractions are extracted at later stage in the fractionation process, and generally have much higher protein content, higher solubility and considerably lower fibre content. Such protein fractions may contain 45 to 95% protein, depending on process settings and raw material composition. They can also be used as feed ingredients, particularly in high value applications such as starter feed, fish feed, pet food and calf milk replacer, but should preferably be used in the functional food protein market.

Emulsified Oil Fractions

The emulsified oil fractions are obtained from the fractionation of oilseed cakes. Alternatively to separating oil and the other components from this fraction, a novel end-use of the entire fraction is disclosed. The fact that it contains proteins and phospholipids, makes it an interesting source of highly digestible oil for animal feeding. This is of particular interest as an ingredient in added value compound feed containing either very high energy values or highly digestible oil.

A preferred embodiment of a plant for carrying out the invention is shown in the attached drawing, wherein 1 denotes a suspension, hydrolysis and heat treatment vessel 1 connected to a wet mill 2 for enhanced enzyme action and dispersion of hydrolysis end-product. The slurry is heat-treated with live steam after the completion of hydrolysis in vessel 1, and optionally further heat-treated in a heat exchanger 3 to inactivate enzymes. The enzyme inactivation step may be avoided when the end-products are targeted at the feed market. The hydrolysate with approximately 20% dry matter content is transferred to a 3-phase decanter 4, which separates fibre residue, emulsified oil and solubles. Fibre residue and emulsified oil are dried in dryers 6 and 5, respectively. A soluble phase is re-suspended in water in vessel 7 and separate in decanter 8 into two phases. The supernatant is filtered through an ultrafilter 9 to yield a permeate and a retentate phase. The permeate phase is concentrated in evaporator 10 and the resulting syrup is fractionated in separator 11 into a sugar-rich fraction and a phytate-rich fraction. The retentate phase is dried in drier 14 to yield a protein-rich fraction (60-95% protein). The precipitate from decanter 8 is re-suspended in water in vessel 12 and separated in separator 13 into two protein-rich fractions of distinct protein composition (30-65% protein), nutritive value and functionality, which are then dried in dryers 14.

1. Process for the wet fractionation of oil seed press cake and/or meal,
characterized in
that oil seed press cake or meal is dispersed in water and subjected to a combined treatment of wet milling, enzymes and heat, followed by a sequential fractionation at an elevated temperature using centrifugal forces and size exclusion (ultrafiltration) so as to yield one or more fibrous-rich fractions, at least three different protein-rich fractions, optionally an oil-rich fraction, a sugar-rich fraction and a phytate-rich fraction, followed by a final step consisting of drying or partial evaporation of the above-said fractions.

2. Process according to claim 1,
wherein oil seed press cake or meal is the residual fibrous-protein fraction obtained from conventional oil extraction processes of oil seeds of the type Soya, rapeseed, cottonseed, sunflower, linseed and flax seed.

3. Process according to claims 1-2,
wherein the combination of wet milling, enzymatic and heat treatment is carried out to achieve a high efficiency in the subsequent fractionation of the main components of oilseed press-cake and meal, i.e. fibre, protein, oil, sugars and phytate, and that an extraction rate of both protein, residual fat and phytate of at least 70% from the original material is achieved.

4. Process according to claims 1-3,
wherein the enzymatic treatment is accomplished by using one or a combination of more than one of the following enzymes: beta-glucanase, xylanase, hemicellulase, arabinase and pectinase.

5. Process according to claim 1,
wherein an enzyme inactivation step is carried out prior to the fractionation step or drying step.

6. Protein fraction obtained in accordance with the process of claims 1-5,
wherein the said fraction is provided in a dry form with at least 880/% dry matter, and it is comprised of one or more protein fractions produced in the said process, and it contains 30 to 950/% protein, and 1 to 60% oil.

7. Protein fraction obtained in accordance with the process of claims 1-4,
wherein the said fraction is provided in a dry form with at least 88% dry matter, and it is comprised of one or more protein fractions produced in the said process, and it contains 30 to 95% protein, 1 to 60% oil, and it contains active enzymes of the type used in the process.

8. Oil fraction obtained in accordance with the process of claims 1-5,
wherein the said fraction is provided as an emulsified oil, and it is comprised of one or two oil fractions produced in the said process, and it contains at least 60% fat, and less than 30% protein.

9. Oil fraction obtained in accordance with the process of claims 1-4,
wherein the said fraction is provided as an emulsified oil, and it is comprised of one or two oil fractions produced in the said process, and it contains at least 60% fat, and less than 30% protein, and it contains active enzymes of the type used in the process.

10. Fibre fraction obtained in accordance with the process of claims 1-5,
wherein the said fraction in provided in a dry form with at least 88% dry matter, and it is comprised of at least 50% fibre, 15% protein and 10% fat.

11. Fibre fraction obtained in accordance with the process of claims 1-4,
wherein the said fraction in provided in a dry form with at least 88% dry matter, and it is comprised of at least 50% fibre, 15% protein and 10% fat, and it contains active enzymes of the type used in the process.

12. Sugar fraction obtained in accordance with the process of claims 1-5,
wherein the said fraction in provided in a syrup form with at least 75% dry matter, and it consists of at least 50% neutral and acidic sugars.

13. Sugar fraction obtained in accordance with the process of claims 1-4,
wherein the said fraction in provided in a syrup form with at least 75% dry matter, and it consists of at least 50% neutral and acidic sugars, and it contains active enzymes of the type used in the process.

14. Phytate fraction obtained in accordance with the process of claims 1-5,
wherein the said fraction in provided in a dry form and contains 30 to 80% phytate.

15. Use of a protein fraction, as described in claim 6, in food or feed applications as a protein ingredient or functional protein to replace other protein products from vegetable, animal and microbial sources.

16. Use of a protein fraction, as described in claim 7, in feed applications as a protein ingredient to replace other protein products from vegetable, animal and microbial sources, with active enzymes used in the process for enhanced nutritive value.

17. Use of an oil fraction, as described in claim 8, in food or feed applications as a fat substitute or emulsifier to replace other fat products from vegetable and animal sources.

18. Use of an oil fraction, as described in claim 9, in feed applications as a fat substitute or emulsifier to replace other fat products from vegetable and animal sources, with active enzymes used in the process for enhanced nutritive value.

19. Use of a fibre fraction, as described in claim 10, in feed applications as a balanced feed ingredient.

20. Use of a fibre fraction, as described in claim 11, in feed applications as a balanced feed ingredient, with active enzymes used in the process for enhanced nutritive value.

21. Use of a fibre fraction, as described in claim 11, as a biomass source used in combustion for producing heat and/or other energy.

22. Use of a syrup fraction, as described in claim 12, in feed applications as an energy source or a compound feed binder, or as a media for microbial fermentation.

23. Use of a syrup fraction, as described in claim 13, in feed applications as an energy source or compound feed binder, with active enzymes used in the process for enhanced nutritive value.

24. Use of a phytate fraction, as described in claim 14, in food and feed applications as an anti-oxidant and taste enrichment agent and in nutraceutical/cosmoceutical/pharmaceutical applications as a cancer-preventing, urinary calculi-preventing and bacterial tooth plaque-preventing agent.

25. Use of a phytate fraction, as described in claim 14, in nutraceutical/cosmoceutical/pharmaceutical applications as a cancer-preventing.

26. Use of a phytate fraction, as described in claim 14, in nutraceutical/cosmoceutical/pharmaceutical applications as a urinary calculi-preventing agent.

27. Use of a phytate fraction, as described in claim 14, in nutraceutical/cosmoceutical/pharmaceutical applications as a bacterial tooth plaque-preventing agent.

28. Use of a phytate fraction, as described in claim 14, as a paper coating agent.

29. Use of a phytate fraction, as described in claim 14, as a water treatment agent.

30. Use of a phytate fraction, as described in claim 14, as an ion exchange matrix.

31. Use of a phytate fraction, as described in claim 14, as an anti-oxidant coating on solid substrates.

32. Set up for carrying out the process according to claims 1-5,
characterized in
that it comprises a hydrolysis and heat treatment vessel (1), a wet mill (2), a heat exchanger (3) for enzymatic inactivation, mixing tanks (7, 9 and 12), decanters (4 and 8), separators (11 and 13), an ultra-filter (9), an evaporator (10), and dryers (5, 6 and 14).
